(19) United States
(12) Patent Application Publication
(10) Pub. No.: US 2013/0339254 A1
(43) Pub. Date: Dec. 19, 2013

(54) Task Repository

(71) Applicants: Oleg Figlin, Kingston Upon Thames (DE); Hermann Reiter, St Leon-Rot (DE)

(72) Inventors: Oleg Figlin, Kingston Upon Thames (DE); Hermann Reiter, St Leon-Rot (DE)

(21) Appl. No.: 13/525,142

(22) Filed: Jun. 15, 2012

(51) Int. Cl. G06Q 10/06

(52) U.S. Cl. 705/301

(57) ABSTRACT

A task repository can include content including at least one of defined tasks and pre-packaged services that are usable in responding to queries formed based on a work breakdown structure into which a set of customer requirements including data characterizing deliverables associated with a service-based project are converted. A set of results returned in response to the query can include one or more of associated defined task units and pre-packaged services for a search term associated with each discrete work element in the work breakdown structure such that a completed representation of the project can be formed.

### TECHNICAL FIELD

The subject matter described herein relates to a repository that can retain information pertaining to tasks that can be combined as part of more complex projects, services, or the like.

### BACKGROUND

A professional services company, such as for example an organization that provides consulting services, other task-based services in which value is derived primarily from human capital or completion of projects or the like that are tailored to an individual customer's needs, can nonetheless engage in one or more similar tasks that are applied or combined according to a desired end result of a particular project, service, or the like. For example, an engineering company might perform numerous different projects that include similar tasks relating to assessment of a construction or installation site. A manufacturing or product distribution company can typically rely upon features of an enterprise resource planning application or software architecture that maintains data relating to inventory, assembly costs, shipping, invoicing, and the like in a discrete and reproducible manner and that can therefore assist company personnel in preparing accurate estimates and predictions of the scope of work required to fill an order, the costs, the time to delivery, and the like. However, such features are not as readily applied to a professional services company.

### SUMMARY

A task repository can support an automated or at least semi-automated, standardized approach to activities such as scoping, planning, estimating, and the like for service-based projects. Such activities have historically required substantial expert input and have been difficult to improve based on pre-existing content because such content is not usually present in an easily accessible form or location. A task repository can support responses to queries formed based on work breakdown structure into which a set of customer requirements including data characterizing deliverables associated with a service-based project is converted.

Implementations of the current subject matter can include, but are not limited to, systems and methods consistent including one or more features as described below as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating features of different delivery models for service-based projects;

FIG. 2 is a diagram illustrating aspects of an example of a software architecture showing features consistent with implementations of the current subject matter;

FIG. 3 is a diagram illustrating aspects of another example of a software architecture showing features consistent with implementations of the current subject matter;

FIG. 4 is a diagram illustrating aspects of a repository showing features consistent with implementations of the current subject matter; and

FIG. 5 is a process flow diagram illustrating aspects of a method having one or more features consistent with implementations of the current subject matter.

When practical, similar reference numbers denote similar structures, features, or elements.

### DETAILED DESCRIPTION

Standardized delivery models for handling services within an enterprise resource planning (ERP) framework or other business software architecture can include the following: “expert-based,” in which one or more highly skilled consultants deliver highly customized, “one-off” services; “design-based,” in which projects are scoped and completed within a traditional framework of pre-defined blueprinting or planning with added leverage added through knowledge management (KM) and business process modeling systems and approaches; “assemble-to-order,” in which a project is assembled using predefined building blocks within standardized delivery approach (described in more detail below); and “industrialized” or “commoditized,” in which highly packaged services with fixed scope, fixed price, and the like are delivered in an automated way and in which only limited or minimal limited interaction is required with the end customer.

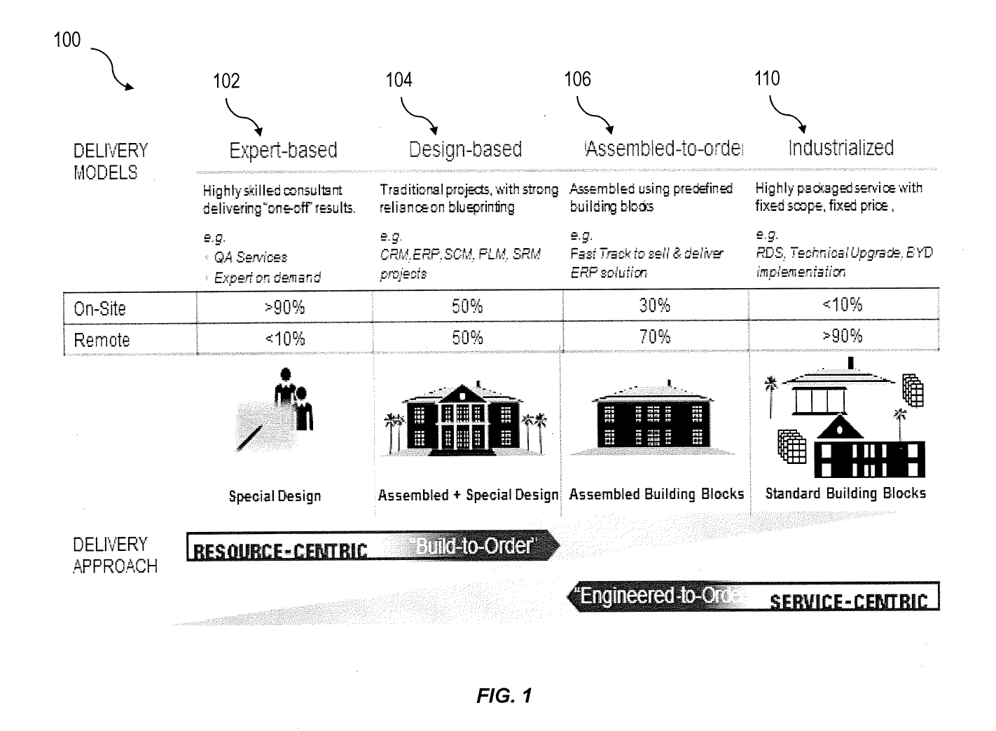

Examples of these delivery models are further discussed with reference to the diagram 100 of FIG. 1. For example, an expert-based delivery model 102 can include highly skilled consultants delivering “one-off” results, such as for example custom projects or services that are tailored to a specific customer. Examples of such projects can include, but are not limited to, quality assurance services, on demand services, or the like, which can be characterized by special design requirements, often with a resource-centric approach that requires a very high percentage (e.g. as much as approximately 90% or more) of on-site (as opposed to remote) labor. A design-based delivery model 104 can include more “traditional” projects, often with a song reliance on blueprinting and the like. Examples of such projects can include, but are not limited, to implementation of systems and the like for providing customer relationship management (CRM), enterprise resource planning (ERP), supply chain management (SCM), product lifecycle management (PLM), supplier relationship management (SRM), and the like, which can be characterized by a combination of special design requirements and assembly of predefined building blocks, often with more of “build to order” approach that requires a lower percentage (e.g. approximately 50% or more) of on-site labor as compared to an approximately equal amount of remote effort. An assemble to order delivery model 106 can include projects that are assembled almost entirely using predefined building blocks or tasks. Examples of such projects can include, but are not limited, to fast tracking to sell and deliver a customized ERP solution, or the like, which can be characterized by an assembly of predefined building blocks, often with more of an “engineered to order” approach that relies more heavily (e.g. as much as approximately 70% of more of remote labor, with the balance being on-site labor. An industrialized or commoditized delivery model 110 can include highly packaged services with fixed scope and often with a fixed or highly inflexible price. Examples of such projects can include, but are not limited to, out of the box relational database systems, technical upgrades, remote configurations of software as a service arrangements, or the like, which can be characterized as sale of standard building blocks, often with a service-centric approach that relies largely (e.g. as much as approximately 90% or more) on remote labor.

Assembly of services and other building blocks both in the bid and delivery phases can be difficult unless the necessary content regarding tasks to be assembled into the service or services that are part of the set of customer requirements are easily accessible and can be incorporated into the implementation projects in a straightforward way. In general, content reuse in existing projects using conventional approaches is quite poor because such content is typically dispersed across multiple repositories and does not follow a clear methodology and standards. Accordingly, a large fraction of projects require expert consulting rather than being amenable to an assemble-to-order approach that can substantially improve efficiency in planning, scoping, quoting, and the like.

In a conventional approach to projects that are not readily characterized as commoditized, a project proposal or other scoping activity relating to services being performed or to be performed can typically be assembled in an ad hoc manner. Some existing knowledge of the time and effort generally required to perform a given type of task can be relied upon in putting together a project proposal. For example, an individual manager might have re-usable content at his or her disposal that has resulted from activities of his or her group of direct reports, but no global resource for consistent and reproducible application of content generated by other groups within an organization. Content re-use can be very difficult using conventional approaches because information relating to task descriptions, service capabilities, resources, costs, and the like is typically stored in multiple sources, which significantly complicates navigation of this information and its assembly in association with a new project. Additionally, there are no clear standards on how to harvest knowledge from existing projects and where to store it. Implementations of the current subject matter can provide a task repository that enables an efficient, structured approach and assembly of granular service tasks for different project types. The ability to apply an assemble-to-order approach to a larger variety of professional services can provide substantial improvements.

An assemble-to-order approach can be characterized as one in which a product or a service is assembled on receipt of the sales order. Key components are planned or stocked in anticipation of the sales order. Receipt of the order initiates assembly of the customized product. The assemble-to-order approach can be useful where a large number of finished products can be assembled from common components. Use of an assemble-to-order strategy can enable resource and/or material availability at the moment when a sales order is created. A customer can be quoted a reliable delivery date for the deliverable resulting from a project because it can be readily determined whether the tasks required to complete the project to satisfy the customer requirements will be available on the desired date. If a commitment cannot be made to completing al aspects of a project by a given deadline, the ERP application or other business software architecture that includes at least some similar functionality can provide information regarding when the full project can be expected to be completed and whether a commitment can be made to provide a partial set of deliverables.

Use of an assemble-to-order based approach can require support for assembly of project tasks based on customer requirements. Assembly on a task level can be quite difficult (if even possible) using conventional approaches due to limited visibility into different repositories that can generally include only parts of the overall data required to fully implement an assemble-to-order approach. In particular, content from a variety of sources can be difficult to assemble if the different content sources do not follow common standards. Many currently available systems and approaches for providing cross-platform, transparent access to data in multiple data sources, such as for example ERP software architectures and the like, lack a common repository for storing non-coded assets of the various data services and for extracting such assets at a task level.

Examples of features consistent with an implementation of the current subject matter can include, without limitation, the establishment of a harmonized and holistic task repository that can include both task data and accelerators representative of a wide variety of services via a single portal, or optionally in a single data repository. It will be well understood that the term “single data repository” can refer to a single database system with all data stored in computer-readable media at a single physical location or, alternatively, to a “cloud” repository approach in which the relevant data are stored in numerous physical locations but are accessible via a common front end interface. Using such an approach, assembly of projects from defined services and tasks and reuse of existing content can be enabled.

Implementations of the current subject matter can provide one or more advantages. For example, project assembly can be accomplished via access to a central tasks repository that supports convenient storage, navigation, and assembly of tasks for different projects types. Additionally, an integrated, optionally unitary, methodology framework can be used in conjunction with structured content blocks to ensure user access to easy to consume services tasks. Advantages provided by implementations of the current subject matter can also include, but are not limited to, lowering the total cost of implementation, time-to-value, and services-to-software ratio by capturing content in a structured way, automating recurring activities, and supporting reuse.

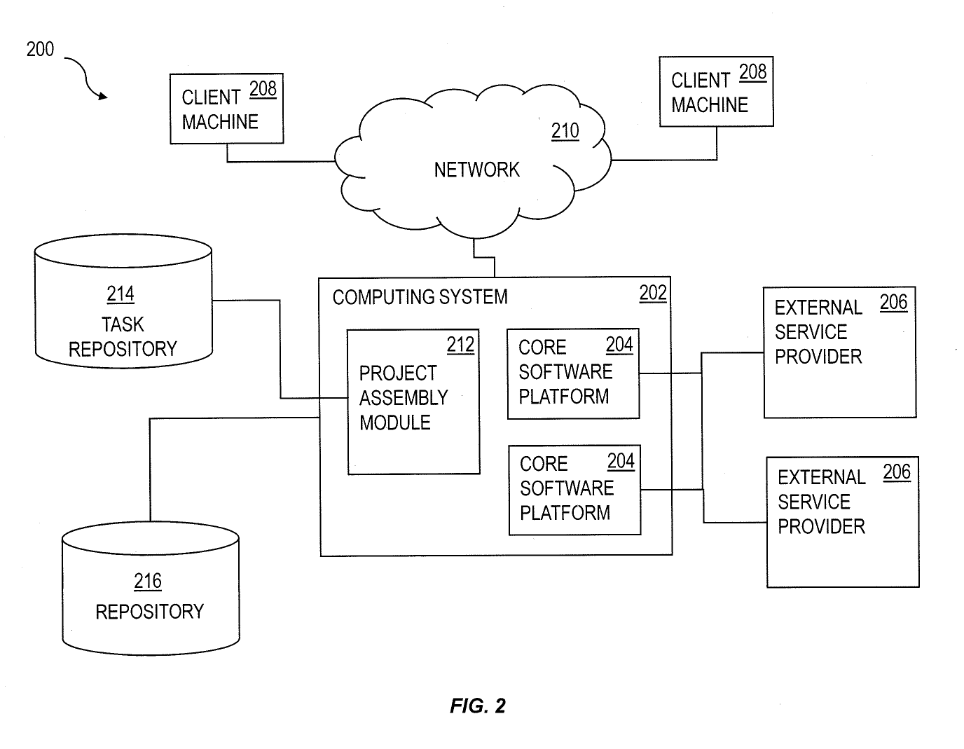

The core software platform of an enterprise resource planning (ERP) system, other business software architecture, or other database functionality can in some implementations be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available business software solution to work with organization-specific business processes and functions is feasible. FIG. 2 shows a diagram of a system consistent with such an implementation. A computing system 202 can include one or more core software platform modules 204 providing one or more features of the business software system. In some implementations, the computing system 202 can be an application server. The computing system 202 can also aggregate or otherwise provide a gateway via which users can access functionality provided by one or more external service providers 206. Examples of external service providers 206 can include one or more computing systems supporting database functionality or other software functionality created or provided from a partner or other third party software developer. This external service provider database functionality or other software functionality can be provided over either direct or networked connections if the one or more external provider computing systems are separate from the computing system 202 that includes one or more core software platform modules 204. Alternatively, the external service provider database functionality or other software functionality can be hosted on the computing system 202 that includes the one or more core software platform modules 204.

Client machines 208 can access the computing system, either via a direct connection, a local terminal, or over a network 210 (e.g. a local area network, a wide area network, a wireless network, the Internet, or the like). A project assembly module 212 or multiple such modules can execute on the computing system 202, on one or more separate systems, or any combination thereof to perform one or more of the project assembly operations discussed in greater detail below. For the remainder of this disclosure, the project assembly module 212 will be discussed in the singular. However, it will be readily understood that one or more features of the methods, techniques, approaches, etc. relating to functionality ascribed to a single project assembly module 212 can be performed by multiple modules, which can be implemented within a single system that includes one or more processors or on multiple systems that each include one or more processors. The project assembly module 212 can access a task repository 214, which, as noted above, can be part of or directly accessible to the computing system 202, or, alternatively or in addition, can be located remotely or optionally spread over one or more physical or virtual servers, for example as in a cloud computing arrangement. The project assembly module or modules 212 can execute on the computing system 202, on one or more separate application servers, or any combination thereof to perform one or more of the project assembly operations discussed in greater detail below.

The computing system 202 can include or otherwise be provided with access over a direct or networked connection to one or more repositories 216 that can retain one or more of metadata for use by at least one of the one or more core software platform modules 204 and the database functionality or other software functionality provided by one or more external service providers 206. The one or more repositories 216, or optionally the project assembly module or modules 212 can store objects or other elements, such as for example business objects, metadata objects, or the like. These objects or other elements can include definitions of business scenarios, business processes, and one or more business configurations as well as data, metadata, master data, etc. relating to definitions of the business scenarios, business processes, and one or more business configurations, and/or concrete instances of the data objects (e.g. business objects) that are relevant to a specific instance of the business scenario or a business process. In some implementations, a business object or other metadata object can include a template definition of a standard business process or other related functionality. The template definition can optionally be modified via one or more extensions that can also be stored in the one or more repositories 216. The one or more repositories can also include storage for data relating to the business or other aspects of the organization.

Smaller organizations can also benefit from use of business software functionality. However, such an organization may lack the necessary hardware resources, IT support, and/or consulting budget necessary to make use of a standalone business software architecture product and can in some cases be more effectively served by a software as a service (SaaS) arrangement in which the business software system architecture is hosted on computing hardware such as servers and data repositories that are maintained remotely from the organization's location and accessed by authorized users at the organization via a thin client, such as for example a web browser, over a network.

In a software delivery configuration in which services of an business software system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

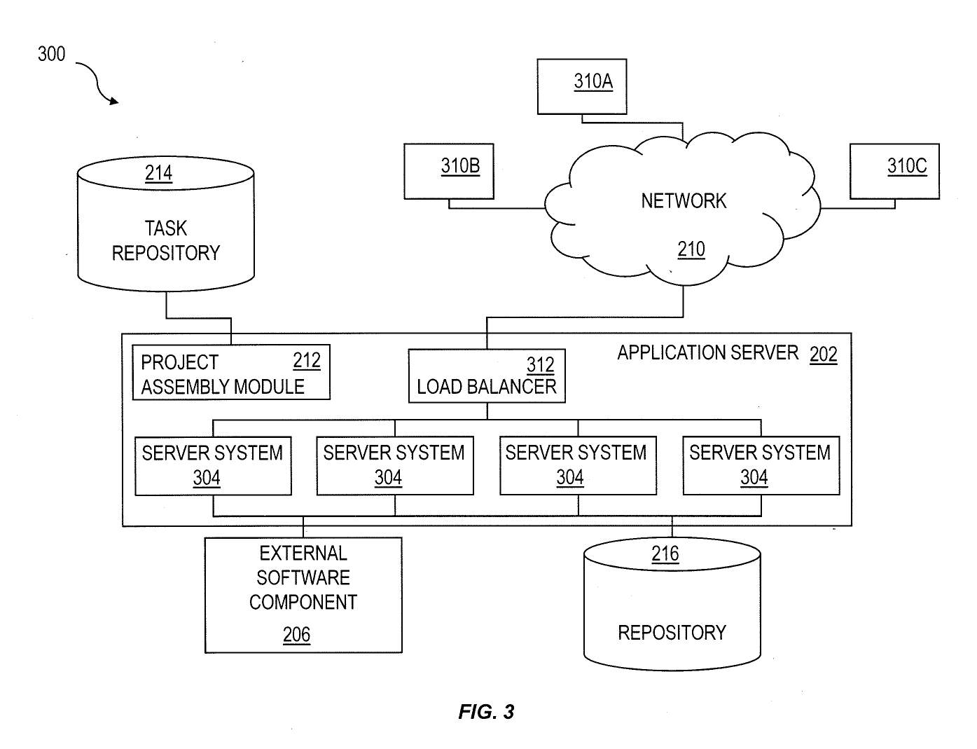

FIG. 3 shows a block diagram of a multi-tenant implementation of a software delivery architecture 300 that includes an application server 302, which can in some implementations include multiple server systems 304 that are accessible over a network 306 from client machines operated by users at each of multiple organizations 310A-310C (referred to herein as “tenants” of a multi-tenant system) supported by a single software delivery architecture 300. For a system in which the application server 302 includes multiple server systems 304, the application server can include a load balancer 312 to distribute requests and actions from users at the one or more organizations 310A-310C to the one or more server systems 304. Instances of the core software platform 204 (not shown in FIG. 3) can be executed in a distributed manner across the server systems 304. A user can access the software delivery architecture across the network using a thin client, such as for example a web browser or the like, or other portal software running on a client machine. The application server 302 can access data and data objects stored in one or more repositories 216 which can make one or more of metadata and other data available for use by at least one of the one or more core software platform modules 204 and the database functionality or other software functionality provided by one or more external service providers 206. The application server 302 can also serve as a middleware component via which access is provided to one or more external software components 206 that can be provided by third party developers.

As in the standalone system 200 of FIG. 2, a project assembly module 212 or multiple such modules can execute on the computing system 202, on one or more separate systems, or any combination thereof to perform one or more of the project assembly operations discussed in greater detail below. The project assembly module 212 can access a task repository 214, which, as noted above, can be part of or directly accessible to the application server 302, or, alternatively or in addition, can be located remotely or optionally spread over one or more physical or virtual servers, for example as in a cloud computing arrangement. The project assembly module or modules 212 can execute on the application server 302, on one or more separate application servers, or any combination thereof to perform one or more of the project assembly operations discussed in greater detail below.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 302 that includes multiple server systems 304 that handle processing loads distributed by a load balancer 312. Potential benefits from such an arrangement can include, but are not limited to, high and reliably continuous application server availability and minimization of unplanned downtime, phased updating of the multiple server systems 304 to permit continuous availability (one server system 304 can be taken offline while the other systems continue to provide services via the load balancer 312), scalability via addition or removal of a server system 304 that is accessed via the load balancer 312, and de-coupled life cycle events or processes (such as for example system maintenance, software upgrades, etc.) that enable updating of the core software independently of tenant-specific customizations implemented by individual tenants.

As in the example illustrated in FIG. 2, the repository 216 can store a business object that represents a template definition of a standard business process. Each individual tenant 310A-310C can customize that standard template according to the individual business process features specific to business of the organization to which that tenant is assigned. Customizations can be stored as extensions in the metadata repository.

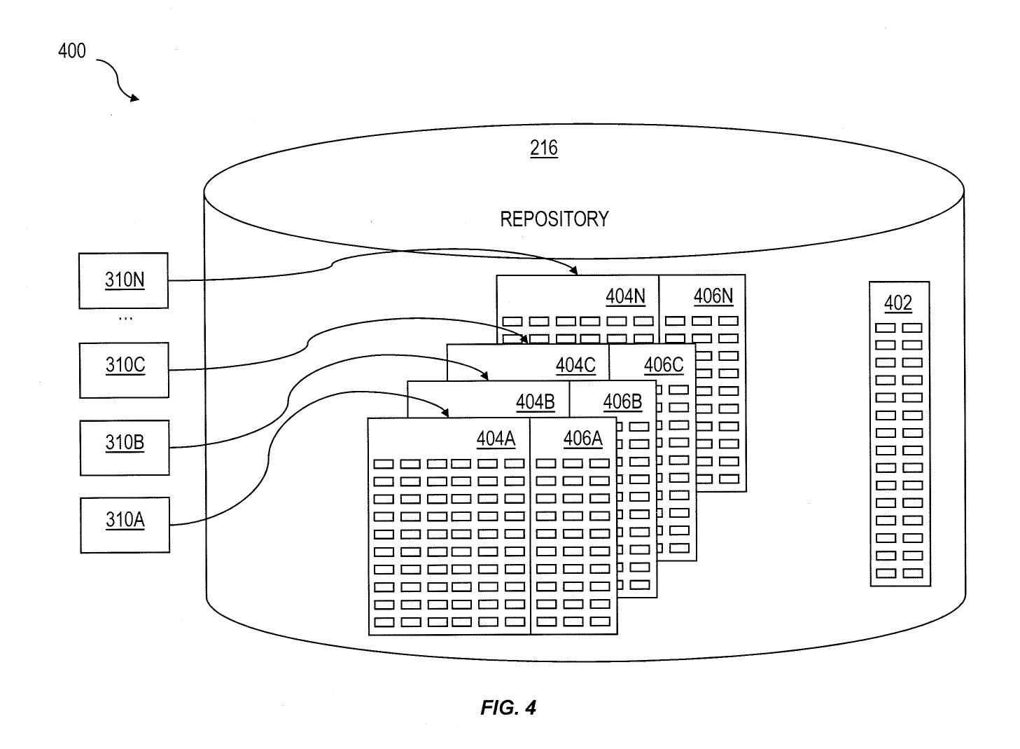

To provide for customization of the business process for each of multiple organizations supported by a single software delivery architecture 300, the data and data objects stored in the metadata repository 216 and/or other data repositories that are accessed by the application server 302 can include three types of content as shown in FIG. 4: core software platform content 402 (e.g. a standard definition of a business process), system content 404, and tenant content 406. Core software platform content 402 includes content that represents core functionality and is not modifiable by a tenant. System content 404 can in some examples be created by the runtime of the core software platform and can include core data objects that store concrete data associated with specific instances of a given business process and that are modifiable with data provided by each tenant. Metadata relating to one or more of core software platform content 402, system content 404, and content provided by the one or more external service providers 206 can optionally be part of a system tenant that is accessible from all other tenants 310A-310N. Master data and metadata can optionally be retained in the project assembly module or modules 212 while the metadata repository 216 can retain one or more accelerators including process descriptions. Alternatively, the one or more accelerators can also be retained in the project assembly module or modules 212, or both of the master data and metadata as well as the accelerators can be retained in the metadata repository 216.

The data and/or the metadata retained in the tenant content 406 can be tenant-specific: for example, each tenant 310A-310N can store information about its own inventory, sales orders, etc. as well as metadata pertaining to extensions, processes, or the like that are specific to the organization assigned to that tenant. Tenant content 406A-406N can therefore include data objects or extensions to other data objects that are customized for one specific tenant 310A-310N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 406 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 402 and system content 404 and tenant content 406 of a specific tenant are accessed to provide the business process definition and/or the status information relating to a specific instance of the business process according to customizations and business data of that tenant such that each tenant is provided access to a customized solution whose data are available only to users from that tenant.

One or more life cycle events or processes of an application server 202 can cause invalidation of the metadata retained in a buffer 212. A life cycle event in this context can refer to one or more of an import, an upgrade, a hot fix, or the like of one or more business objects or other data objects into a core software platform module 204 of a business software architecture or the database functionality or other software functionality provided by one or more external service providers 206. In the example of a multi-tenant approach such as described above in reference to FIG. 3 and FIG. 4, life cycle events affecting features of one or more core software platform modules 204 or of database functionality or other software functionality provided by one or more external service providers 206 can be performed in the system tenant. Similarly, other life cycle events that affect multiple tenants (e.g. scalable add-ons that can be active in multiple tenants) can also be performed on the system tenant. Life cycle events that affect only one tenant, for example upgrading, importing, hot fixing, etc. of an add-on or other custom feature that is used by only a single customer of the business software architecture; switching on or of a scalable add-on functionality for a single tenant; creating or modifying an extension to core software platform content 402, system content 404, or database functionality or other software functionality provided by one or more external service providers 206; or the like can be implemented only in the affected tenant.

A task repository 214 and an associated project assembly module or modules 212 or other computer-implemented functionality having one or more similar features can provide a “one stop shop,” or, in other words, a unified approach to combining tasks and content as part of the assembly of resources for responding to customer requirements associated with a project or other deliverable. As an example, a task repository 214 and associated project assembly module 212 can provide a common resource for use by stakeholders in an organization who are involved in content or service creation, bid and delivery phases (e.g. bid managers, project managers, consultants, or the like), etc. Implementations of the current subject matter can thereby provide and support readily consumed services and tasks based on an integrated methodology framework.

The task repository 214 can optionally be been seeded with initial content that can in turn be maintained using an authoring application that is part of the project assembly module 214. Current attributes can be supported so that attribute changes per table can be maintained. It can also be possible to create, update and delete data in master data tables, in content tables (e.g. concrete instances of tasks and descriptions thereof), and in lookup tables, based on permissions assigned to various user roles.

A task repository 214 consistent with implementations of the current subject matter can be accessed by a predefined model, which can optionally be provided within the project assembly module 212. The predefined model or other features of the project assembly module 212 can assemble the requirements for a project to respond to a specific set of customer requirements in an at least partially automated manner. This process can occur as a result of aggregation of tasks into services, which are ultimately combined to produce a defined project for responding to the set of customer requirements.

The term “service” as used herein can refer to a set of activities that solve, address, or improve a specific customer requirement. A customer requirement or a set of customer requirements refers to aspects of a project or service being performed by one or more members of an organization for a customer of that organization. The organization can, in some implementations, be a user or purchaser of software functionality provided by an ERP application or other business software architecture. A customer can be a person, company, corporation, or other entity that receives results of a project or service either in exchange for payment or other compensation or without such compensation. A service can be an assembly of one or more tasks. A task can be considered as a smallest granular unit of activity that can be combined with one or more additional instances of the same task or with other tasks in necessary proportions, sizes, scales, or the like to create a service that addresses at least part of the set of customer requirements. Multiple services can be further aggregated to complete assembly of a project or set of services in satisfaction of the set of customer requirements.

Scope, effort, and duration criteria associated with task definitions in the task repository 214 can be tailored specifically to requirements of the organization. This tailoring can be done by one or key users at the organization, by individual users at the organization, by one or more consultants or third party vendors, or the like. Alternatively or in addition, one or more pre-defined task definitions, accelerators, or the like can be packaged and provided, sold as an add-on, or the like to the organization by a vendor of an ERP application or other business software architecture. In this manner, the services necessary to respond to all or part of a set of customer requirements can be assembled based on ready-to-use content and service components for end-to-end processes with clearly defined scope, delivery model, timeline, and effort. Standardized services can be delivered via specially designed project methods with a set of scoping parameters, such as for example an estimated time, cost, effort, etc. A service can be “standardized” when a pre-defined service offering is customized to a specific capability or other resource of the organization. Scope, effort and duration can be dependent on the organization's business needs and on the project size and complexity. The service approach can be customized each time it is delivered for each business scenario of the organization, for example for each type of project or set of services needed by a customer of the organization. In other words, the task repository 214 can be pre-loaded with a plurality of content items that each relate to a minimum combinable task unit. These content items can include generic content items that are provided to handle common tasks or services (e.g. by a vendor of an ERP application, other business software, an externals service provider, or the like as part of a core software platform, an upgraded feature pack, an add-on, or the like), custom-made content items that are entirely designed consistent with the needs of the organization, modified content items that are based on generic content items with one or more customized parameters to match the needs of the organization, or the like.

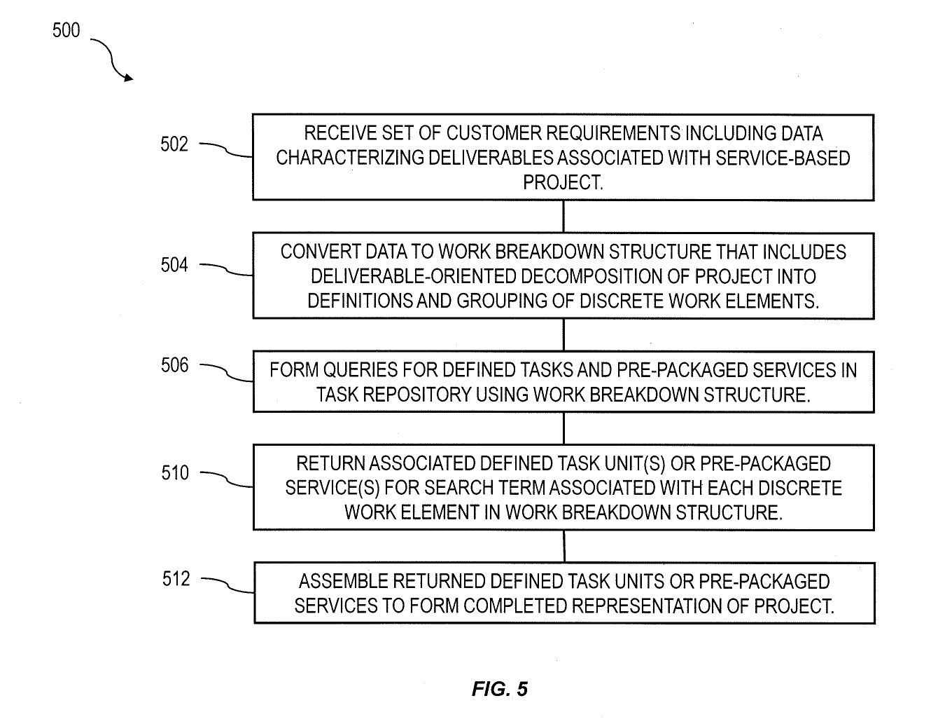

FIG. 5 shows a process flow chart 500 illustrating method features, one or more of which can be included in an implementation of the current subject matter. A set of customer requirements can be received at 502. Receipt of the set of customer requirements can occur at one or more computing systems that can include one or more computer processors. The set of customer requirements can optionally include one or more of structured and unstructured data characterizing deliverables associated with a service-based project. As used herein, the term unstructured data generally refers to any data stored in an unstructured format at an atomic level, or, in other words, to information that lacks a pre-defined data model, does not fit well into relational tables, or the like.

If the set of customer requirements includes unstructured data, these unstructured data can optionally be converted to structured data. Structured data can include data managed by a database management system or other technology that allows for querying and reporting against predetermined data types and understood relationships. Alternatively or in addition, structured data can include assignments of information to existing categories, fields, types, or other organizational characteristics. The converting of the customer requirements into structured data can occur manually, or alternatively using one or more of data mining or extraction applications or programs, artificial intelligence, pattern matching, or the like.

The data of the set of customer requirements can be converted to a work breakdown structure at 504. A work breakdown structure can include, for example, a deliverable-oriented decomposition of a project into smaller elements or components. A work breakdown structure can define and group discrete work elements (e.g. tasks) of a project in a way that helps organize and define the total work scope of the project and can provide a common framework for the natural development of the overall planning and control of a contract by providing a basis for dividing work into definable increments from which a statement of work can be developed and technical, schedule, cost, and labor hour reporting can be established. Consistent with implementations of the current subject matter, the work breakdown structure can be generated using the structured data characterizing the set of customer requirements.

At 506 the work breakdown structure is used to form queries for application to task repository content that includes one or more of defined tasks and pre-packaged services stored in a task repository 214. The queries can optionally be formed using a search application, which can be part of a project assembly module 212. A search application can provide for task-specific and service-specific searches on the task repository 214 and can optionally utilize task-specific and service-specific attributes, such as for example, industry, customer relationship management (CRM) features, extended warehouse management (EWM) features, or the like to allow for useful search results. A CRM application can support interactions with customers, clients, and sales prospects and the like while an EWM application can support planned and efficient processing of logistics processes. The query results can return at 510 one or more associated defined task units or pre-packaged services for a search term associated with each element in the work breakdown structure. The associated attributes utilized in the search algorithm can be customizable according to an organization's business processes.

The task repository 214 can store task descriptions that can be used in the query based on the work breakdown structure as a form of “lowest common denominator” or granular element. Each task stored in the task repository 214 can be combinable with other tasks, perhaps in multiples as needed to recreate a conceptual model of the set of customer requirements. Prior to being stored in the task repository, individual task units can be prepared, for example by being defined through input received from one or more persons with expert knowledge of the underlying tasks and how they can be combined into services, by being harvested from existing projects (e.g. using pattern recognition, artificial intelligence, or the like on data characteristic of prior or in-progress services), or the like.

A deployment cockpit or one or more software modules or functionality, which can optionally be part of the project assembly module 212, can extract task and service data from the task repository 214 at 512 based on the query results. The task repository 214 can provide, for example via XML or some other structured language, task data for a given service that is part or all of the set of customer requirements. The deployment cockpit can query the task repository 214 for a given defined task unit or pre-packaged service, and the task repository can return data related to the associated tasks for the given defined task unit or pre-packaged service. A defined task unit or pre-packaged service stored in the task repository 214 can include scoping parameters associated with the defined task unit or prepackaged service. Scoping parameters can optionally include one or more of a role, number of man hours/man days (effort), deployment mode (near shore, off shore, local), delivery mode (remote or on-site). The defined task unit or pre-packaged service can also include a uniform resource locator (URL) or other link to a specific content accelerator corresponding to the discrete work element associated with the defined task unit or pre-packaged service. The content accelerator can describe features of the defined task unit or pre-packaged service and can include one or more of guidance, tools, or the like regarding setting of scoping parameters to quantify one or more of time, cost, availability, or the like associated with completion of a concrete instance of the defined task unit or pre-packaged service.

A promise to delivery (PtoD) application, another project management solution, or one or more software modules or functionality, which can optionally be part of the project assembly module 212, can extract data from the task repository 214. Task level data can be extracted for a service or group of services. In addition, ad-hoc queries can be generated out of the PtoD application to support individual tasks to be added to a work set. A resource management (RM) application or one or more software modules or functionality, which can optionally be part of the project assembly module 212, can provide sourcing for role-based information from the task repository. In a conventional approach, creation of an RM request for a service can generally require a separate step for each role or task in the services. A task repository 214 and the project assembly module 212 having features consistent with an implementation of the current subject matter can feed the RM application one or more roles for a given service as well as additional service-specific attribute information. The RM application can take this data and automate the creation of associates RM requests to staff the delivery of that service.

At 512, the defined task units or pre-packaged services returned from the query or queries of the from the task repository 214 are assembled to form a completed representation of the discrete work elements of the work breakdown structure. This completed representation includes clearly defined deliverables and can leverage templates, best practices or other project accelerators as well as pricing guidelines as part of a service offering.

Implementations of the current subject matter can provide one or more benefits or advantages. For example, one or more of a reduced total cost of implementation, time-to-value, and services-to-software ratio can be offered by capturing content in a structured way, automating recurring activities, and ensuring reuse of pre-established content items. An integrated, end-to-end solution can combine preconfigured software and task repository content that includes one or more of defined task units and pre-packaged services into a single approach for creating customized bids, work plans, or the like. The defined task units or pre-packaged services can also include preconfigured content in some implementations. In this manner, tailor-made consulting services can be supported with realistic, organization-specific resources allocation abilities.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by a system comprising at least one programmable processor, cause the system to perform operations comprising:
receiving, at the system, a set of customer requirements including data characterizing deliverables associated with a service-based project;
converting the data to a work breakdown structure, the work breakdown structure comprising a deliverable-oriented decomposition of the project into a plurality of definitions of discrete work elements;
forming at least one query for application to a set of task repository content comprising at least one of defined tasks and pre-packaged services, the task repository content being stored in a task repository, the at least one query being formed using the work breakdown structure;
returning a set of results, the set of results comprising at least one of associated defined task units and pre-packaged services for a search term associated with each discrete work element in the work breakdown structure; and
assembling the returned set of results to form a completed representation of the project.

2. A computer program product as in claim 1, wherein the task repository stores task descriptions for use in the query formed using the work breakdown structure and wherein each task stored in the task repository is combinable with other tasks in arbitrary multiples as needed to recreate a conceptual model of the set of customer requirements.

3. A computer program product as in claim 1, wherein the data in the set of customer requirements comprises at least one of structured data and unstructured data.

4. A computer program product as in claim 1, wherein the data in the set of customer requirements comprises unstructured data, and the operations further comprise converting the unstructured data to structured data.

5. A computer program product as in claim 1, wherein the work breakdown structure defines and groups the discrete work elements of the project to organize and define the total work scope of the project and to provide a basis for dividing the discrete work elements into definable increments.

6. A computer program product as in claim 1, wherein the forming of the queries is performed using a search application that provides for task-specific and service-specific searches on the task repository.

7. A system comprising:
at least one programmable processor; and
a machine-readable medium storing instructions that, when executed by the at least one processor, cause the at least one programmable processor to perform operations comprising:
receiving, at the system, a set of customer requirements including data characterizing deliverables associated with a service-based project;
converting the data to a work breakdown structure, the work breakdown structure comprising a deliverable-oriented decomposition of the project into a plurality of definitions of discrete work elements;
forming at least one query for application to a set of task repository content comprising at least one of defined tasks and pre-packaged services, the task repository content being stored in a task repository, the at least one query being formed using the work breakdown structure;
returning a set of results, the set of results comprising at least one of associated defined task units and pre-packaged services for a search term associated with each discrete work element in the work breakdown structure; and
assembling the returned set of results to form a completed representation of the project.

8. A system as in claim 7, wherein the task repository stores task descriptions for use in the query formed using the work breakdown structure and wherein each task stored in the task repository is combinable with other tasks in arbitrary multiples as needed to recreate a conceptual model of the set of customer requirements.

9. A system as in claim 7, wherein the data in the set of customer requirements comprises at least one of structured data and unstructured data.

10. A system as in claim 7, wherein the data in the set of customer requirements comprises unstructured data, and the operations further comprise converting the unstructured data to structured data.

11. A system as in claim 7, wherein the work breakdown structure defines and groups the discrete work elements of the project to organize and define the total work scope of the project and to provide a basis for dividing the discrete work elements into definable increments.

12. A system as in claim 7, wherein the forming of the queries is performed using a search application that provides for task-specific and service-specific searches on the task repository.

13. A computer-implemented method comprising:
receiving, at the system, a set of customer requirements including data characterizing deliverables associated with a service-based project;
converting the data to a work breakdown structure, the work breakdown structure comprising a deliverable-oriented decomposition of the project into a plurality of definitions of discrete work elements;
forming at least one query for application to a set of task repository content comprising at least one of defined tasks and pre-packaged services, the task repository content being stored in a task repository, the at least one query being formed using the work breakdown structure;
returning a set of results, the set of results comprising at least one of associated defined task units and pre-packaged services for a search term associated with each discrete work element in the work breakdown structure; and
assembling the returned set of results to form a completed representation of the project.

14. A computer-implemented method as in claim 13, wherein the task repository stores task descriptions for use in the query formed using the work breakdown structure and wherein each task stored in the task repository is combinable with other tasks in arbitrary multiples as needed to recreate a conceptual model of the set of customer requirements.

15. A computer-implemented method as in claim 13, wherein the data in the set of customer requirements comprises at least one of structured data and unstructured data.

16. A computer-implemented method as in claim 13, wherein the data in the set of customer requirements comprises unstructured data, the method further comprising converting the unstructured data to structured data.

17. A computer-implemented method as in claim 13, wherein the work breakdown structure defines and groups the discrete work elements of the project to organize and define the total work scope of the project and to provide a basis for dividing the discrete work elements into definable increments.

18. A computer-implemented method as in claim 13, wherein the forming of the queries is performed using a search application that provides for task-specific and service-specific searches on the task repository.

19. A computer-implemented method as in claim 13, wherein at least one of the receiving, the converting, the forming, the returning, and the assembling is performed by at least one programmable processor.
